(19) United States
(12) Patent Application Publication
(10) Pub. No.: US 2006/0017933 A1
(43) Pub. Date: Jan. 26, 2006

(54) Heterodyne laser interferometer with porro prisms for measuring stage displacement

(76) Inventors: W. Clay Schluchter, Los Altos, CA (US); L. Hakchu Lee, San Jose, CA (US)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/897,467

(22) Filed: Jul. 23, 2004

(51) Int. Cl. G01B 9/02

(52) U.S. Cl. 356/493

(57) ABSTRACT

An interferometer system for measuring a displacement along a first direction includes (1) a measurement roof optic (e.g., a porro prism) mounted to a stage translatable along the first direction, (2) a polarizing beam splitter having (a) a first face opposite the measurement roof optic and (b) a second face opposite the first face, (3) a first wave plate located between the measurement roof optic and the first face of the polarizing beam splitter, and (4) a redirecting optic located opposite the first face of the polarizing beam splitter. A measurement path through the system includes only segments located substantially in a plane defined by the first direction and a second direction orthogonal to the first direction.

### DESCRIPTION OF RELATED ART

A standard plane mirror interferometer configuration can be used for a multi-axis measurement of stage displacement and rotation. However, this configuration has a disadvantage for rotation measurements. As the stage rotates, the measurement beam translates, or walks off, relative to the reference beam location on the detector. The magnitude of the overlap of the reference and measurement beams decreases with this walk-off. Any solution that reduces this walk-off has superior dynamic range.

Rotations of the stage about an arbitrary axis can create an angle between reference and measurement beams (also called “beam pointing”) in addition to creating walk-off. Both effects limit the dynamic range of the measurements. Corner and roof reflectors have been implemented in a number of forms to minimize beam pointing and extend the dynamic range.

Double pass “roof” mirror interferometer designs have been implemented in the past. U.S. Pat. No. 6,208,424 (“de Groot”) discloses an exemplary double pass roof mirror design. The de Groot design requires a large space on the stage for measuring one axis because the measurement beam is separated both vertically (Z-direction) and horizontally (Y-direction) to strike the roof mirror at four different locations. This is an undesirable feature for wafer lithography. As the stage size requirement is large, stages limited by the measurement requirement are larger and heavier. Heavier stages can in turn limit the wafer throughput. In general, minimizing the space on the stage required for a displacement measurement can help wafer throughput.

Thus, what is needed is an interferometer design that minimizes the walk-off and the angle between reference and measurement beams while reducing the stage size requirement.

### SUMMARY

In one embodiment of the invention, an interferometer system for measuring a displacement along a first direction includes (1) a measurement roof optic (e.g., a porro prism) mounted to a stage translatable along the first direction, (2) a polarizing beam splitter having (a) a first face opposite the measurement roof optic and (b) a second face opposite the first face, (3) a first wave plate located between the measurement porro prism and the first face of the polarizing beam splitter, and (4) a redirecting optic located opposite the first face of the polarizing beam splitter. A measurement path through the system includes only segments located substantially in a plane defined by the first direction and a second direction orthogonal to the first direction.

### BRIEF DESCRIPTION OF THE DRAWINGS

FIGS. 1, 2, and 3 illustrate an interferometer system that minimizes beam pointing and walk-off in one embodiment of the invention.

FIGS. 4, 5, and 6 illustrate an interferometer system that minimizes beam pointing and walk-off in another embodiment of the invention.

FIG. 7 illustrates a variation of the interferometer system in FIGS. 1, 2, and 3 in one embodiment of the invention.

Use of the same reference numbers in different figures indicates similar or identical elements. Figures are not drawn to scale and are for illustrative purposes only.

### DETAILED DESCRIPTION

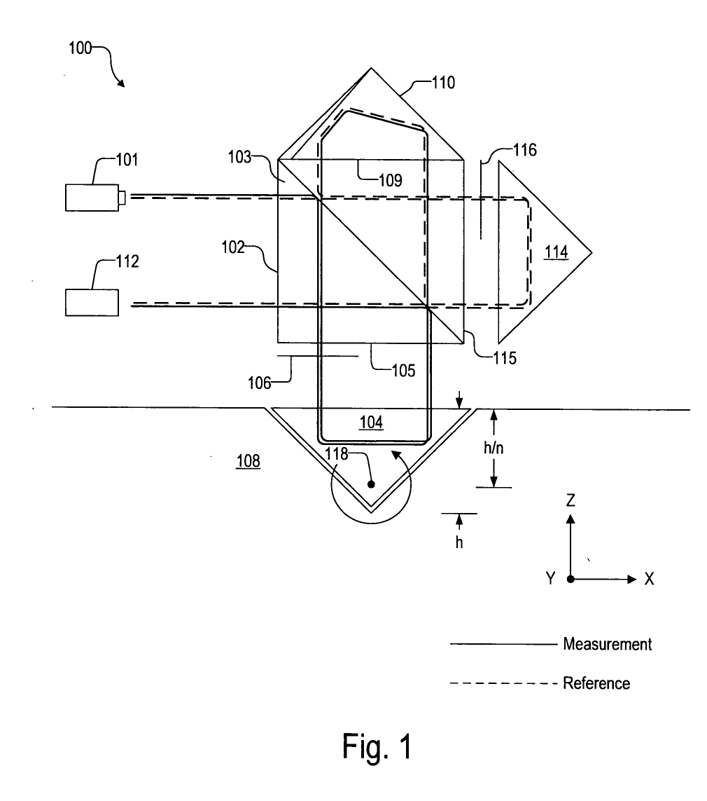

FIG. 1 illustrates an interferometer system 100 in one embodiment of the invention. Although oriented to measure displacement along the Z-direction, system 100 can be oriented to measure along any axis.

A laser source 101 directs a coherent, collimated light beam to a left face 102 of a polarizing beam-splitter (PBS) 103. The light beam consists of two orthogonally polarized frequency components. One frequency component f_{A} (e.g., a measurement beam initially S-polarized with respect to the PBS hypotenuse face) enters the system's measurement path while the other frequency component f_{B} (e.g., a reference beam initially P-polarized with respect to the PBS hypotenuse face) enters the system's reference path.

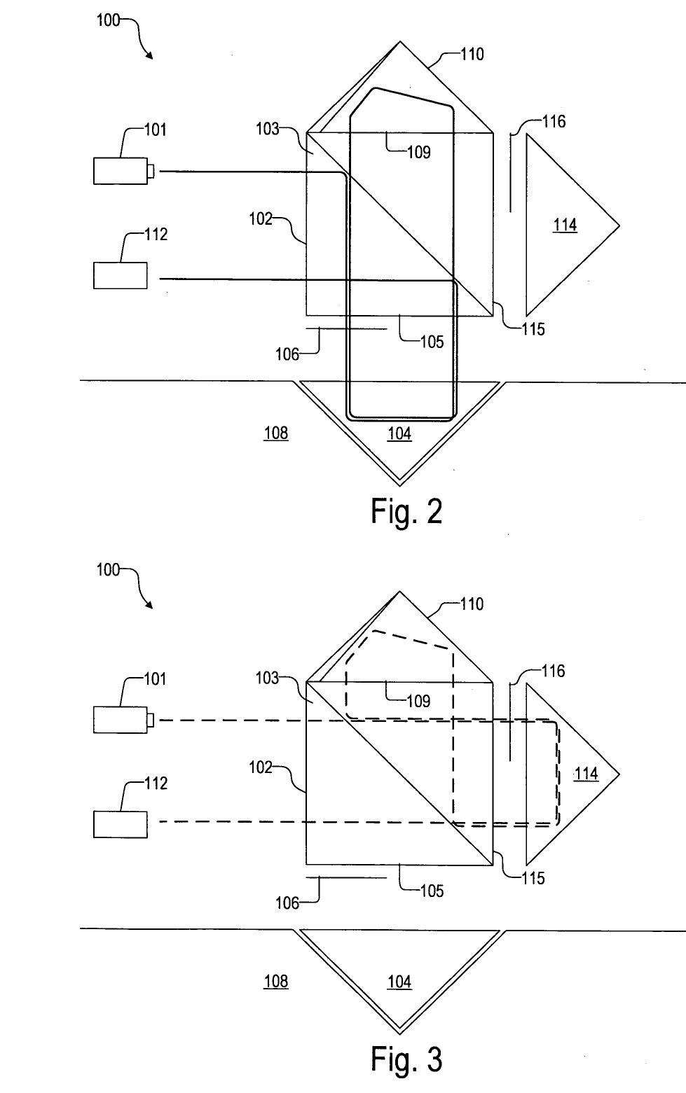

FIG. 2 illustrates the measurement path alone. The measurement path includes two passes to a measurement roof optic 104 (e.g., a porro prism). A porro prism is a 45-90-45° reflecting prism having two reflecting faces that form the 90° angle for reflecting the light beam through a total angle of 180°. Measurement porro prism 104 is mounted to a stage 108 whose translation along the Z-direction is to be measured. In a first measurement pass, a polarizing beam-splitter (PBS) 103 reflects the measurement beam through a lower face 105 to a half-wave plate 106. Half-wave plate 106 rotates the polarization state of the measurement beam from the S-polarization to the P-polarization. The measurement beam then propagates to one reflecting surface of measurement porro prism 104. Measurement porro prism 104 has its apex, which extends into or out of the page, substantially along the Y-direction. Measurement porro prism 104 reflects the measurement beam from two reflecting surfaces and the measurement beam exits in an offset path and without tilt relative to the input beam about the Y-direction back to PBS 103. As the measurement beam is substantially P-polarized when it impinges measurement porro prism 104, there is little phase shift caused by the reflection from measurement porro prism 104. Nonetheless, an appropriate coating may be provided on the input face of measurement porro prism 104 to reduce any undesired phase shift.

PBS 103 now transmits the measurement beam through an upper face 109 to a redirecting optic 110 (e.g., a cube corner retroreflector). Cube corner 110 reflects the measurement beam from three reflecting surfaces and the measurement beam exits cube corner 110 in an offset but parallel path back to PBS 103. Thus, cube corner 110 offsets the measurement beam in the X-direction and retroreflects beam tilts due to stage rotation about the X-direction. An appropriate coating may be provided on the reflecting faces of cube corner 110 to reduce any undesired phase shift. PBS 103 again transmits the measurement beam through lower face 105 toward half-wave plate 106, which starts a second measurement pass through system 100.

In the second measurement pass, half-wave plate 106 rotates the polarization state of the measurement beam back from the P-polarization to the S-polarization. The measurement beam then propagates to measurement porro prism 104. Measurement porro prism 104 again reflects the measurement beam in an offset path and without tilt relative to the input beam about the Y-direction back to PBS 103. PBS 103 now reflects the measurement beam through a left face 102 to detector 112.

FIG. 3 illustrates the reference path alone. The reference path includes two passes to a reference roof optic 114 (e.g., a porro prism). In a first reference pass, PBS 103 transmits the reference beam through a right face 115 to a half-wave plate 116. Half-wave plate 116 rotates the polarization state of the reference beam from the P-polarization to the S-polarization. The reference beam then propagates to one reflecting surface of reference porro prism 114.

Reference porro prism 114 has its apex, which extends into or out of the page, substantially along the Y-direction. Reference porro prism 114 reflects the reference beam from two reflecting surfaces and the reference beam exits in an offset path and without tilt relative to the input beam about the Y-direction back to PBS 103. Reference porro prism 114 also helps to match the optical path through glass in the reference path of the interferometer with the optical path through glass in the measurement path, which minimizes thermal effects. As the reference beam is substantially S-polarized when it impinges reference porro prism 114, there is little phase shift caused by the reflection from reference porro prism 114. Nonetheless, an appropriate coating may be provided on the reflecting faces of reference porro prism 114 to reduce any undesired phase shift. In one embodiment, porro prism 114 is replaced with a retroreflector. In this embodiment, the measurement and reference paths would be the same as those illustrated in FIG. 1.

PBS 103 now reflects the reference beam through upper face 109 to cube corner 110. Cube corner 110 reflects the reference beam from three reflecting surfaces and the reference beam exits in an offset but parallel path back to PBS 103. PBS 103 reflects the reference beam toward half-wave plate 116, which starts a second reference pass through system 100.

In the second reference pass, half-wave plate 116 rotates the polarization state of the reference beam from the S-polarization back to the P-polarization. The reference beam then propagates to reference porro prism 114. Reference porro prism 114 again reflects the reference beam in an offset path and without tilt relative to the input beam about the Y-direction back to PBS 103. Referring to FIG. 1, PBS 103 now recombines the reference beam with the measurement beam and transmits them to detector 112. Detector 112 then measures the change in the phase of the recombined beam to determine the relative displacement of stage 108 along the Z-direction.

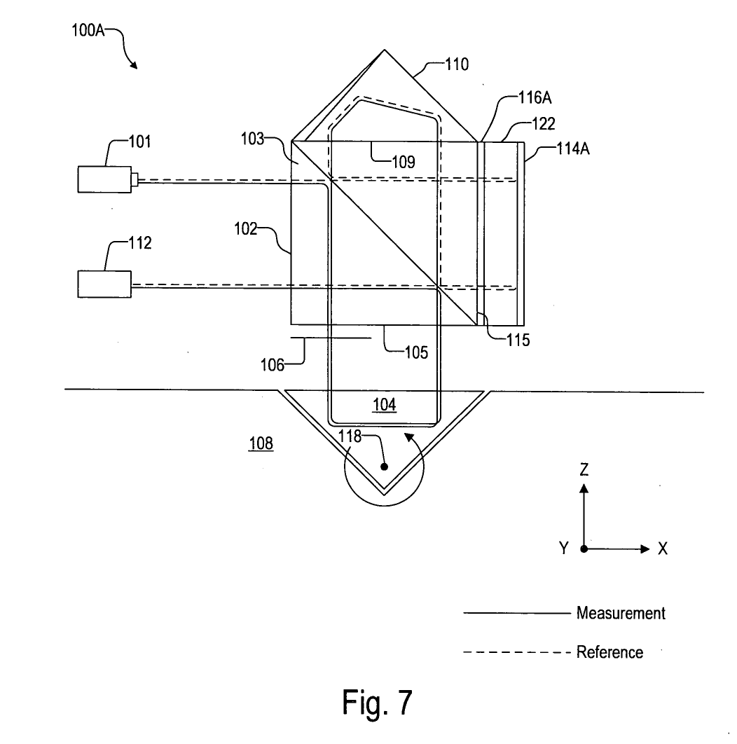

FIG. 7 illustrates an interferometer system 100A, which is a variation of interferometer system 100 in one embodiment of the invention. In system 100A, reference porro prism 114 is replaced with a reference plane mirror 114A and half-wave plate 116 is replaced with a quarter-wave plate 116A that extends across right face 115 of PBS 103. To ensure the optical path through glass in the measurement and reference paths are balanced, a glass slug 122 is placed between quarter-wave plate 116A and reference plane mirror 114A. Alternatively, glass slug 122 can be placed between quarter wave plate 116A and PBS 103. Also, quarter wave plate 116A, or glass slug 122, can be coated with a reflective coating that replaces reference plane mirror 114A.

The measurement path in system 100A is the same as the measurement path in system 100 and will not be repeated.

In the reference path, PBS 103 transmits the reference beam through quarter-wave plate 116A and glass slug 122 onto reference plane mirror 114A. Reference plane mirror 114A reflects the reference beam back onto itself and back through quarter-wave plate 116A. As the reference beam passes through quarter-wave plate 116A twice, the newly S-polarized reference beam is reflected by PBS 103 into cube corner 110. Cube corner 110 returns the reference beam in an offset but parallel path into PBS 103.

PBS 103 reflects the reference beam through quarter-wave plate 116A and glass slug 122 onto reference plane mirror 114A. Reference plane mirror 114A reflects the reference beam back onto itself and back through quarter-wave plate 116A. The newly P-polarized reference beam is recombined with the measurement beam and transmitted by PBS 103 onto detector 112.

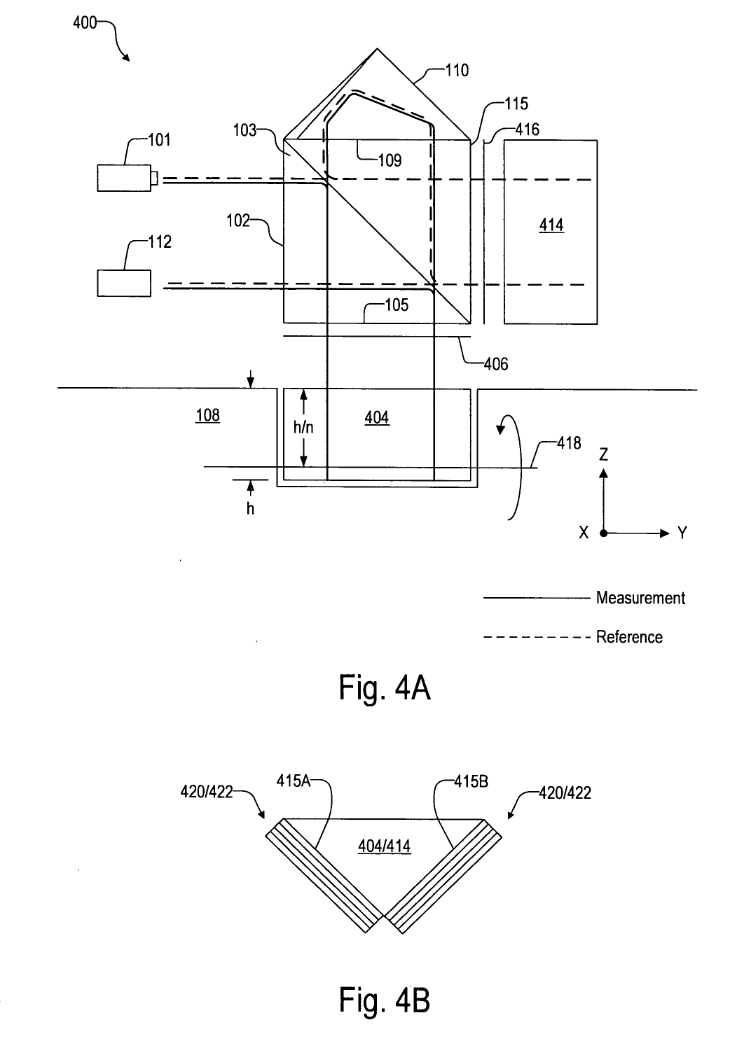

FIG. 4 illustrates an interferometer system 400 in one embodiment of the invention. Although oriented to measure displacement along the Z-axis, system 400 can be oriented to measure along any axis.

As described above, laser source 101 directs a light beam consisting of two orthogonally polarized frequency components to left face 102 of PBS 103. Again one frequency component f_{A} (e.g., a measurement beam initially S-polarized with respect to the PBS hypotenuse face) enters the system's measurement path while the other frequency component f_{B} (e.g., a reference beam initially P-polarized with respect to the PBS hypotenuse face) enters the system's reference path.

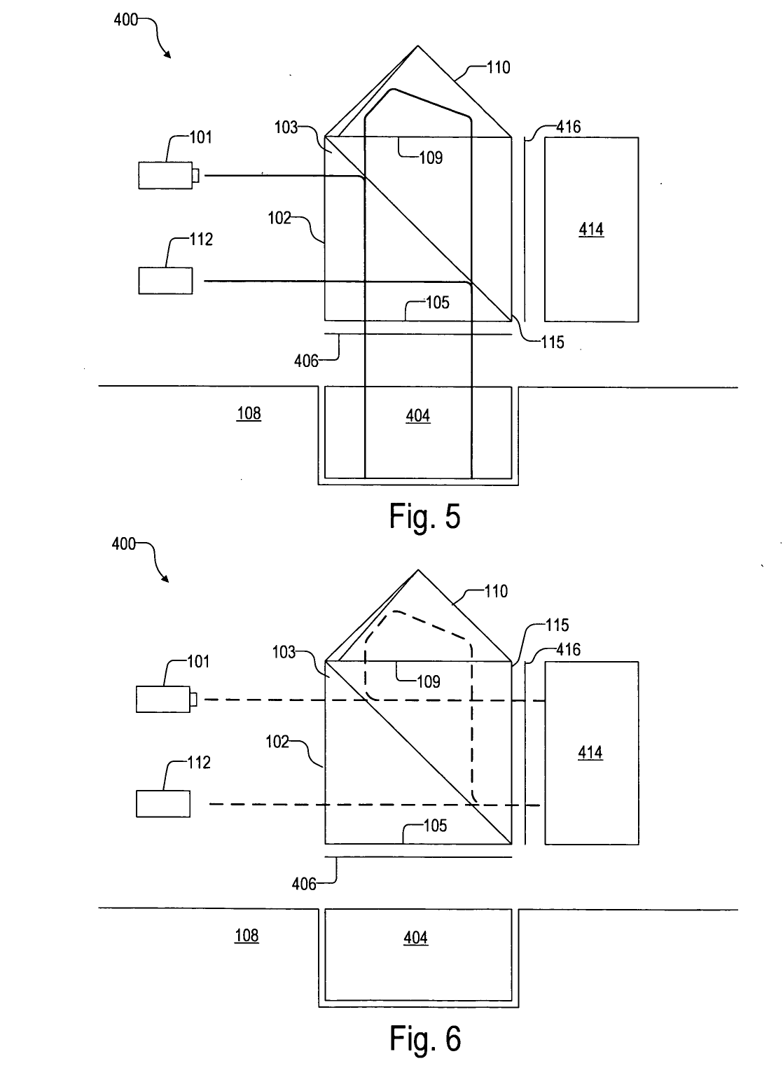

FIG. 5 illustrates that the measurement path alone. The measurement path includes two passes to a measurement roof optic 404 (e.g., a porro prism) mounted to stage 108 whose translation along the Z-direction is to be measured. In a first measurement pass, PBS 103 reflects the measurement beam through lower face 105 to a quarter-wave plate 406. Quarter-wave plate 406 transforms the linearly polarized light to circularly polarized light. The measurement beam then impinges the apex of measurement porro prism 404. Measurement porro prism 404 has its apex, which extends horizontally on the page, substantially along the Y-direction. Measurement porro prism 404 reflects the measurement beam without tilt relative to the input beam about the Y-direction back through quarter-wave plate 406.

As the measurement beam is circularly polarized when it impinges measurement porro prism 404, the reflection from prism 404 may cause an undesired phase shift and change the polarization of the measurement beam from circular to elliptical. Thus, for a measurement porro prism 404 made of a single piece of glass, an appropriate coating 420 (FIG. 4B) may be provided on the two reflecting faces of prism 404 to compensate the undesired phase shift and shift handedness from left to right or from right to left. Producing 180 (modulo 360) degrees phase shift between S and P polarization will achieve this goal.

In one embodiment for a BK7 measurement porro prism 404, coating 420 includes a first layer of silicon dioxide (SiO₂) having a quarter wave optical thickness (QWOT) of 1.7504 and formed on the uncoated glass faces 415A and 415B of prism 404, a second layer of titanium dioxide (TiO₂) layer having a QWOT of 1.2771 and formed on the first layer, a third layer of SiO₂ having a QWOT of 1.6731 and formed on the second layer, and a fourth layer of TiO₂ having a QWOT of 1.9918 and formed on the third layer. QWOT is equal to 4*n*t divided by λ, where n is the refractive index, t is the physical thickness, and λ is the design wavelength. The indices of refraction of TiO2 and SiO2 are 2.432 and 1.477, respectively at 633 nm design wavelength. Coating 420 can be formed by physical vapor deposition (PVD) with ion assist. Coating 420 on each reflecting surface achieves a 90 degree phase shift between S and P polarizations at an angle of incidence of 45 degrees. Thus, after exiting measurement porro prism 404, coating 420 has produced a total phase shift on the return beam of 180 degrees and the circular polarization will shift handedness from left to right or from right to left.

In other embodiments, a first coating that produces 0 degree phase shift is formed on one reflecting surface of measurement porro prism 404 and a second coating that produces 180 degree phase shift is formed on the other reflecting surface of the measurement porro prism 404. Thus, the coatings produce a total phase shift on the return beam of 180 degrees and the circular polarization will shift handedness from left to right or from right to left.

Referring back to FIG. 5, quarter-wave plate 406 transforms the circularly polarized light to linearly polarized light. The measurement beam then propagates to PBS 103. PBS 103 now transmits the measurement beam through upper face 109 to cube corner 110. Thus, cube corner 110 offsets the measurement beams in the Y-direction and retroreflects beam tilts due to stage rotation about the X-direction. In another embodiment, cube corner 110 is replaced with a porro prism. Cube corner 110 reflects the measurement beam from three reflecting surfaces and the measurement beam exits in an offset but parallel path back to PBS 103. An appropriate coating may be provided on the reflecting faces of cube corner 110 to reduce any undesired phase shift. PBS 103 again transmits the measurement beam through lower face 105 toward quarter-wave plate 406, which starts a second measurement pass through system 400.

In the second measurement pass, half-wave plate 406 transforms the linearly polarized light to circularly polarized light. The measurement beam then impinges the apex of measurement porro prism 404. Measurement porro prism 404 then reflects the measurement beam without tilt relative to the input beam about the Y-direction back through quarter-wave plate 406. Quarter-wave plate 406 transforms the circularly polarized light to linearly polarized light. The measurement beam then propagates to PBS 103. PBS 103 now reflects the measurement beam through left face 102 to detector 112.

FIG. 6 illustrates that the reference path alone. The reference path includes two passes to a reference roof optic 414 (e.g., a porro prism). In a first reference pass, PBS 103 transmits the reference beam through right face 115 to a half-wave plate 416. Half-wave plate 416 transforms the linearly polarized light into circularly polarized light. The reference beam then impinges the apex of reference porro prism 414. Reference porro prism 414 has its apex, which extends horizontally on the page, substantially along the Z-direction. Reference porro prism 414 reflects the reference beam without tilt relative to the input beam about the Z-direction back through quarter-wave plate 416.

As the reference beam is circularly polarized when it impinges measurement porro prism 414, the reflection from prism 414 may cause an undesired phase shift and change the polarization of the measurement beam from circular to elliptical. Thus, for a measurement porro prism 414 made of a solid piece of glass, a coating 422 (FIG. 4B) similar to coating 420 described above may be provided on the reflecting faces of mirror 416 to compensate the undesired phase shift and preserve the circular polarization.

In another embodiment, reference porro prism 414 is replaced with a reference plane mirror. However, if measurement porro prism 404 is made of solid glass, a glass slug may be placed in the reference path to balance the optical path through glass in the measurement and reference paths similar to the configuration shown in FIG. 7.

Referring back to FIG. 6, quarter-wave plate 416 transforms the circularly polarized light to linearly polarized light. The reference beam propagates to PBS 103. PBS 103 now reflects the reference beam through upper face 109 to cube corner 110. Cube corner 110 reflects the reference beam from three reflecting surfaces and the reference beam exits in an offset but parallel path back to PBS 103. PBS 103 again reflects the reference beam through right face 115 toward quarter-wave plate 416, which starts a second reference pass through system 400.

In the second measurement pass, quarter-wave plate 406 transforms the linearly polarized light to circularly polarized light. The measurement beam then impinges the apex of reference porro prism 414. Reference porro prism 404 then reflects the reference beam without tilt relative to the input beam about the Z-direction back through quarter-wave plate 416. Quarter-wave plate 416 transforms the circularly polarized light to linearly polarized light. The reference beam then propagates to PBS 103. PBS 103 now recombines the reference beam with the measurement beam and transmits them to detector 112. Detector 112 then measures the change in the beat frequency of the recombined beam to determine the relative displacement of stage 108 along the Z-direction.

In the operation of systems 100 and 400, porro prisms 104 and 404 accommodate the rotation of stage 108 along the Y-direction by ensuring that the measurement beam enters and exits without tilt relative to the input beam about the Y-direction (i.e., minimizes beam pointing). However, depending on the location of the rotational axes 118 (FIG. 1) and 418 (FIG. 4) of stage 108, the separation between the input and output paths of the measurement beam may change and thereby cause walk-off at detector 112. In this embodiment, rotational axes 118 and 418 are located inside measurement porro prisms 104 and 404 to minimize walk-off at detector 112. The optimum rotational axis occurs parallel to the roof axis of the porro prism. If the height from the input face to of the apex of the porro prism is “h” and the index of the porro prism material is “n,” then this optimum rotational axis is located inside the porro prism at a distance h/n from the input face of the porro prism. The stage can rotate about any axis in general, but rotations of the stage about these other axes cause beam walk-off. Rotations parallel to but offset from the optimum axis are not expected to be a significant limitation of the dynamic range of the system.

In one embodiment, measurement porro prisms 104 and 404 are each replaced with a hollow mirror with two reflective surfaces oriented orthogonal to each other. In this embodiment, rotational axes 118 and 418 can be located at the apex of mirrors 104 and 404 to minimize walk-off at detector 112. Note that other porro prisms in the embodiments described above can also be replaced with this type of mirror.

Systems 100, 100A, and 400 offers space-savings over the prior art. The measurement beam now only strikes measurement porro prism 104 and 404 at two locations, thereby decreasing the overall size of systems 100, 100A, and 400. Specifically, in systems 100 and 100A, the measurement and reference beams only travel in a plane along the X and Z-directions so there is not beam separation along the Y-direction at nominal alignment. In system 400, the measurement and reference beams only travel in a plane along the Y and Z-directions so there is no beam separation along the X-direction at nominal alignment.

Various other adaptations and combinations of features of the embodiments disclosed are within the scope of the invention. “Turned” configurations are shown in the figures, i.e. a configuration where the interferometer input beam is aligned with a direction substantially orthogonal to the measurement axis. However, “unturned” configurations are trivial rearrangements of the components such that the interferometer input beam is inline with the measurement direction. Note that any wave plate described in the embodiments above may be a discrete wave plate or a wave plate coating formed on an optical component. Numerous embodiments are encompassed by the following claims.

1. A system for measuring a displacement along a first direction, comprising:
a measurement roof optic mounted to a stage, the stage being able to translate along the first direction;
a polarizing beam splitter comprising a first face opposite the measurement roof optic and a second face opposite the first face;
a first wave plate located between the measurement roof optic and the first face of the polarizing beam splitter, wherein the first wave plate extends at least partially across the first face of the polarizing beam splitter;
a redirecting optic located opposite the second face of the polarizing beam splitter, wherein a measurement path through the system comprises only segments located substantially in a plane defined by the first direction and a second direction orthogonal to the first direction.

2. The system of claim 1, wherein:
the measurement roof optic is a porro prism and has an apex substantially aligned with a third direction orthogonal to the first direction and the second direction; and
in the measurement path, a measurement beam travels from the polarizing beam splitter through the first wave plate and onto the measurement porro prism, reflects from the measurement porro prism in an offset but substantially parallel path onto the polarizing beam splitter, passes through the polarizing beam splitter onto the redirecting optic, reflects from the redirecting optic in an offset but substantially parallel path onto the polarizing beam splitter, passes through the polarizing beam splitter and the first wave plate onto the measurement porro prism, reflects from the measurement porro prism in an offset but substantially parallel path onto the polarizing beam splitter, and travels from the polarizing beam splitter to a detector.

3. The system of claim 1, wherein:
the measurement roof optic is a porro prism and has an apex substantially aligned with the second direction; and
in the measurement path, a measurement beam travels from the polarizing beam splitter through the first wave plate and onto the apex of the measurement porro prism, reflects from the measurement porro prism substantially back onto itself and onto the first wave plate, passes through the first wave plate and the polarizing beam splitter onto the redirecting optic, reflects from the redirecting optic in an offset but substantially parallel path onto the polarizing beam splitter, passes through the polarizing beam splitter and the first wave plate onto the apex of the measurement porro prism, reflects from the measurement porro prism back onto itself and onto the first wave plate, passes through the first wave plate and onto the polarizing beam splitter, and travels from the polarizing beam splitter to a detector.

4. The system of claim 3, further comprising a phase-compensating coating on uncoated glass reflecting faces of the measurement porro prism.

5. The system of claim 4, wherein the phase-compensating coating comprises:
a first layer on the uncoated glass reflecting faces, the first layer comprising silicon dioxide and a quarter wave optical thickness of 1.7504;
a second layer atop the first layer, the second layer comprising titanium dioxide and a quarter wave optical thickness of 1.2771;
a third layer atop the second layer, the third layer comprising silicon dioxide and a quarter wave optical thickness of 1.6731;
a fourth layer atop the third layer, the fourth layer comprising titanium dioxide and a quarter wave optical thickness of 1.9918, wherein the thicknesses are quarter wave optical thicknesses at a 633 nm design wavelength.

6. The system of claim 1, wherein the polarizing beam splitter further comprises a third face, the system further comprising:
a reference optic located opposite the third face;
a second wave plate located at least partially between the reference optic and the third face of the polarizing beam splitter;
wherein a reference path through the system comprises only segments substantially located in a plane defined by the first direction and the second direction.

7. The system of claim 6, wherein, in the reference path, a reference beam travels from the polarizing beam splitter through the second wave plate onto the reference optic, reflects from the reference optic in an offset but substantially parallel path onto the polarizing beam splitter, reflects from the polarizing beam splitter to the redirecting optic, reflects from the redirecting optic in an offset but substantially parallel path to the polarizing beam splitter, reflects from the polarizing beam splitter through the second wave plate and onto the reference optic, reflects from the reference optic in an offset but substantially parallel path onto the polarizing beam splitter, and travels from the polarizing beam splitter to a detector.

8. The system of claim 7, wherein the first wave plate and the second wave plate are half-wave plates and the reference optic is selected from the group consisting of a porro prism and a retroreflector.

9. The system of claim 6, wherein, in the reference path, a reference beam travels from the polarizing beam splitter through the second wave plate onto the reference optic, reflects from the reference optic substantially back onto itself and into the polarizing beam splitter, reflects from the polarizing beam splitter to the redirecting optic, reflects from the redirecting optic in an offset but substantially parallel path to the polarizing beam splitter, reflects from the polarizing beam splitter through the second wave plate and onto the reference optic, reflects from the reference optic substantially back onto itself and into the polarizing beam splitter, and travels from the polarizing beam splitter to a detector.

10. The system of claim 9, wherein the first wave plate is a half-wave plate, the second wave plate is a quarter-wave plate, and the reference optic is a plane mirror.

11. The system of claim 9, wherein the first wave plate and the second wave plate are quarter-wave plates, and the reference optic is a porro prism comprising an apex substantially aligned with the first direction.

12. The system of claim 11, further comprising a phase-compensating coating on uncoated glass reflecting faces of the porro prism.

13. A method for measuring a displacement along a first direction, comprising providing a measurement path through a polarizing beam splitter, a first wave plate, a measurement roof optic, and a redirecting optic wherein segments of the measurement path are only located in a plane defined substantially along the first direction and a second direction orthogonal to the first direction.

14. The method of claim 13, wherein said providing a measurement path comprises:
directing a measurement beam from the polarizing beam splitter to the first wave plate;
passing the measurement beam through the first wave plate and onto the measurement roof optic, an apex of the measurement roof optic being parallel to a third direction orthogonal to the first and the second directions;
reflecting the measurement beam from the measurement roof optic in an offset but substantially parallel path onto the polarizing beam splitter;
passing the measurement beam through the polarizing beam splitter and onto the redirecting optic;
reflecting the measurement beam from the redirecting optic in an offset but substantially parallel path onto the polarizing beam splitter;
passing the measurement beam through the polarizing beam splitter and the first wave plate onto the measurement roof optic;
reflecting the measurement beam from the measurement roof optic in an offset but substantially parallel path onto the polarizing beam splitter; and
directing the measurement beam from the polarizing beam splitter to a detector.

15. The method of claim 13, wherein said providing a measurement path comprises:
directing a measurement beam reflect from the polarizing beam splitter to the first wave plate;
passing the measurement beam through the first wave plate and onto an apex of the measurement roof optic, the apex of the measurement roof optic being parallel to the second direction;
reflecting the measurement beam from the measurement roof optic substantially back onto itself and onto the first wave plate;
passing the measurement beam through the first wave plate and the polarizing beam splitter onto the redirecting optic;
reflecting the measurement beam from the redirecting optic in an offset but substantially parallel path into the polarizing beam splitter;
passing the measurement beam through the polarizing beam splitter and the first wave plate onto the apex of the measurement roof optic;
reflecting the measurement beam from the measurement roof optic in substantially back onto itself and onto the first wave plate;
passing the measurement beam through the first wave plate and into the polarizing beam splitter; and
directing the measurement beam from the polarizing beam splitter to a detector.

16. The method of claim 15, wherein the measurement roof optic is a porro prism and said reflecting the measurement beam from the measurement roof optic further comprises compensating a phase-shift of the measurement beam to change a handedness of a polarization state of the measurement beam.

17. The method of claim 13, further comprising providing a reference path through the polarizing beam splitter, a second wave plate, a reference optic, and the redirecting optic, wherein segments of the reference path are only located in a plane defined substantially along the first and the second directions.

18. The method of claim 17, wherein said providing a reference path comprises:
directing a reference beam from the polarizing beam splitter through second wave plate onto the reference optic;
reflecting the reference beam from the reference optic in an offset but substantially parallel path into polarizing beam splitter;
reflecting the reference beam from the polarizing beam splitter to the redirecting optic;
reflecting the reference beam from the redirecting optic in an offset but substantially parallel path into the polarizing beam splitter;
reflecting the reference beam from the polarizing beam splitter through the second wave plate and into the reference optic;
reflecting the reference beam from the reference optic in an offset but substantially parallel path into the polarizing bean splitter; and
directing the reference beam from the polarizing beam splitter to a detector.

19. The method of claim 18, wherein the first wave plate and the second wave plate are half-wave plates and the reference optic is selected from the group consisting of a porro prism and a retroreflector.

20. The method of claim 17, wherein said providing a reference path comprises:
directing a reference beam from the polarizing beam splitter through a second wave plate onto the reference optic;
reflecting the reference beam from the reference optic substantially back onto itself and onto the second wave plate;
passing the reference beam through the second wave plate and into the polarizing beam splitter;
reflecting the reference beam from the polarizing beam splitter to the redirecting optic;
reflecting the reference beam from the redirecting optic in an offset but substantially parallel path to the polarizing beam splitter;
reflecting the reference beam from the polarizing beam splitter onto the second wave plate;
passing the reference beam through the second wave plate onto the reference optic;
reflecting the reference beam from the reference optic substantially back onto itself and onto the second wave plate;
passing the reference beam through the second wave plate and into the polarizing beam splitter; and
directing the reference beam from the polarizing beam splitter to a detector.

21. The method of claim 20, wherein the first wave plate is a half-wave plate, the second wave plate is a quarter-wave plate, and the reference optic is a plane mirror.

22. The method of claim 20, wherein the first wave plate and the second wave plate are quarter-wave plates, and the reference optic is a porro prism comprising an apex substantially aligned with the first direction.

23. The method of claim 22, further comprising a phase-compensating coating on uncoated glass reflecting faces of the porro prism.
